(19) United States
(12) Patent Application Publication
(10) Pub. No.: US 2026/0188772 A1
(43) Pub. Date: Jul. 2, 2026

(54) RECYCLING METHOD FOR SOLID ELECTROLYTES AND SOLID ELECTROLYTE CONTAINING ELECTRODES, SEPARATORS, AND CELLS

(71) Applicant: Solid Power Operating, Inc., Louisville, CO (US)

(72) Inventors: Benjamin A. CARLSON, St. John, MN (US); Samuel M. Oberwetter, Lafayette, CO (US); Clara Mauser, Broomfield, CO (US); Brian E. Francisco, Arvada, CO (US)

(21) Appl. No.: 19/429,986

(22) Filed: Dec. 22, 2025

Related U.S. Application Data
(60) Provisional application No. 63/739,070, filed on Dec. 26, 2024.

(51) Int. Cl. H01M 10/54; C01D 15/04; C22B 1/24; C22B 3/22; C22B 7/00

(52) U.S. Cl. CPC H01M 10/54; C01D 15/04; C22B 1/24; C22B 3/22; C22B 7/006

(57) ABSTRACT

Methods for recycling solid electrolytes include contacting the solid electrolyte with a metal halide in a solvent to produce a mixture comprising a metal sulfide, an alkali metal salt, and undissolved material. The undissolved material is removed from the mixture to form a solution, and then the solvent is removed to form a composite that includes a metal sulfide and an alkali metal salt.

### CROSS-REFERENCE TO RELATED APPLICATION

This application is related to and claims priority under 35 U.S.C. § 119 from U.S. Provisional Application No. 63/739,070 filed Dec. 26, 2024, titled “RECYCLING METHOD FOR SOLID ELECTROLYTES AND SOLID ELECTROLYTE CONTAINING ELECTRODES, SEPARATORS, AND CELLS,” which is incorporated by reference herein for all purposes.

### BACKGROUND AND INTRODUCTION

Rechargeable batteries have become a ubiquitous tool that powers a vast majority of our technologies ranging from mobile computing devices to hybrid and full electric vehicles. Historically, the predominant material that powers these batteries is lithium, and industry has resorted to mining this lithium in order to meet its growing need. Recently, there has been a growing interest in recycling these batteries to extract this lithium and use it to make future generations of batteries. However, these recycling processes are not applicable to sulfide-based solid-state batteries due to their sulfide solid electrolyte material. New recycling methods have been developed to accommodate these materials. These new methods attempt to extract the solid electrolyte by dissolving them in solvents and recrystallizing them. Though possible in theory, the extraction processes generate undesirable contaminants resulting in an electrolyte material often not suitable for reuse.

It is with these observations in mind, among others, that aspects of the present disclosure were conceived. In quick summary, instead of extracting and reusing the electrolyte material, described herein, is a low energy method of recycling a solid electrolyte material into highly desirable lithium salts and metal sulfides.

### SUMMARY

Provided herein are methods for recycling a solid electrolyte. The methods generally include contacting a solid electrolyte with a metal halide in a solvent to produce a mixture comprising a metal sulfide, an alkali metal salt, and undissolved material; removing the undissolved material to form a solution; and removing the solvent from the solution to form a composite comprising a metal sulfide and an alkali metal salt. In some embodiments, the solid electrolyte is contained in an electrode layer that comprises an electrode active material, a conductive additive, a binder, and a current collector. In some embodiments, the solid electrolyte is contained in a separator layer. In some embodiments, the molar ratio between the solid electrolyte and the metal halide is from 99:1 to 1:99. In some embodiments, the solid electrolyte comprises lithium, phosphorus and sulfur. In some embodiments, the metal halide comprises boron, silicon, germanium, antimony, tellurium, scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth. In some embodiments, the metal halide comprises fluorine, chlorine, bromine, or iodine. In some embodiments, the solvent comprises an ether, ester, nitrile, imine, or hydrocarbon. In some embodiments, the metal sulfide comprises boron, silicon, germanium, antimony, tellurium, scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth. In some embodiments, the alkali metal salt comprises LiF, LiCl, LiBr, or LiI. In some embodiments, the contacting comprises mixing, grinding, or tumbling. In some embodiments, the undissolved material comprises lithium, phosphorous, sulfur, or a combination thereof. In some embodiments, the undissolved material comprises an alkali metal carbonate, an alkali metal sulfate, an alkali metal phosphate, or an alkali metal hydroxide. In some embodiments, removing the undissolved material comprises filtering, centrifuging, decanting, or a combination thereof. In some embodiments, removing the solvent comprises drying. In some embodiments, the method further includes washing the composite with a solvent to separate the alkali metal salt and the metal sulfide from the undissolved material.

Further provided herein are methods for recycling a solid electrolyte contained in an electrode layer or a separator layer. The methods generally include contacting an electrode layer comprising a solid electrolyte or a separator layer comprising a solid electrolyte with a metal halide in a solvent to produce a mixture comprising a metal sulfide, an alkali metal salt, and undissolved material; removing the undissolved material forming a solution; and removing the solvent from the solution to form a composite containing a metal sulfide and an alkali metal salt. In some embodiments, the molar ratio between the solid electrolyte and the metal halide material is between 99:1 to 1:99. In some embodiments, the solid electrolyte comprises lithium, phosphorus and sulfur. In some embodiments, the metal halide comprises boron, silicon, germanium, antimony, tellurium scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth. In some embodiments, the metal halide comprises fluorine, chlorine, bromine, or iodine. In some embodiments, the solvent comprises an ether, ester, nitrile, imine, or hydrocarbon. In some embodiments, the metal sulfide comprises boron, silicon, germanium, antimony, tellurium scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth. In some embodiments, the alkali metal salt comprises LiF, LiCl, LiBr, or LiI. In some embodiments, the contacting comprises mixing, grinding, or tumbling. In some embodiments, the undissolved material comprises lithium, phosphorous, sulfur, an active material, a conductive additive or a current collector. In some embodiments, removing the undissolved material comprises filtering, centrifuging, decanting, or a combination thereof. In some embodiments, removing the solvent comprises drying. In some embodiments, the method further comprises washing the composite with a solvent to separate the alkali metal salt and the metal sulfide.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic illustration of the general electrolyte recycling process according to the present disclosure.

FIG. 2 shows XRD patterns of the products produced from recycling a solid electrolyte material as described in Example 1 and in Example 2 of the present disclosure.

FIG. 3 shows XRD patterns of the products produced from recycling a solid electrolyte material as described in Example 3 of the present disclosure.

FIG. 4 shows XRD patterns of the products produced from recycling a solid electrolyte material as described in Example 4 of the present disclosure.

### DETAILED DESCRIPTION OF ILLUSTRATED EMBODIMENTS

Various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

In this disclosure, unless otherwise specified, the term “metal” refers to metalloids, transition metals, or post-transition metals, and alloys or mixtures thereof. The term “metal” does not refer to alkali metals.

The current disclosure provides a method of recycling solid electrolyte materials into alkali metal salts and metal sulfides by combining a solid electrolyte (including a separator layer of an electrochemical cell or an electrode layer that includes a solid electrolyte), a metal halide, and a solvent and agitating the combination. When the solid electrolyte and the metal halide are combined with the solvent, a reaction occurs, stripping the alkali metal out of the solid electrolyte and converting the alkali metal into an alkali metal halide while simultaneously producing a metal sulfide. Once this reaction is completed, some of the electrolyte components may be insoluble in the polar organic solvent while some of the resulting alkali metal halide and metal sulfide may form a complex that is soluble in the polar organic solvent. The insoluble electrolyte components may include phosphorus-containing compounds and sulfur-containing compounds, such as P₂S₅ or elemental sulfur. This difference in solubility allows for the alkali metal and the metal sulfide to be separated from the insoluble components by filtering, decanting, or centrifuging. The metal sulfide may be precipitated from solution by the appropriate selection of solvent or by adding a second solvent then removing the desired metal sulfide product. Alternatively, the solution may be removed to form a composite containing the metal sulfide and the alkali metal halide where the metal halide may be washed away by using an appropriate polar organic solvent. The general reactions for this process are:
1. Contacting a solid electrolyte and a metal halide in a solvent

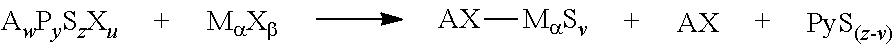

2. Remove undissolved materials

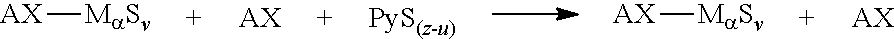

3. Remove solvent

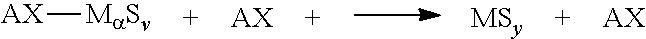

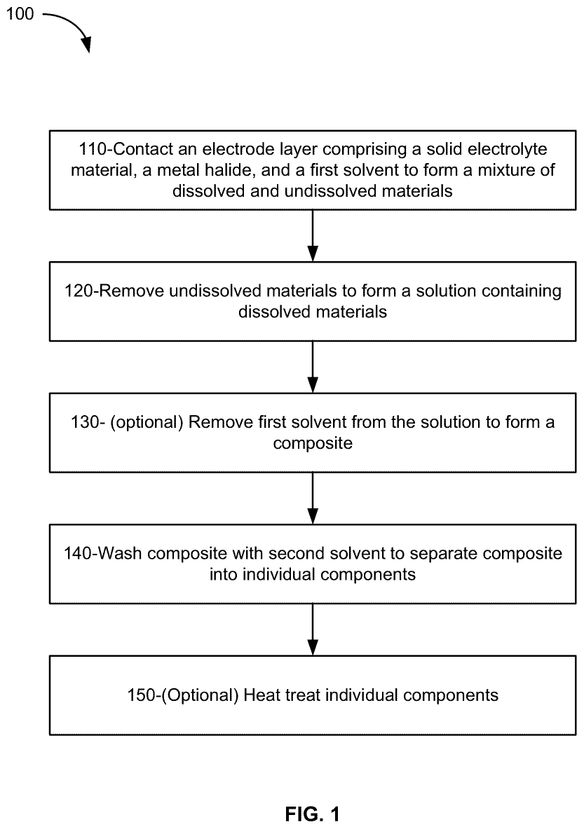

As shown in FIG. 1, in some embodiments, the first step 110 of the recycling process 100 includes contacting a solid electrolyte material (or an electrode layer or a separator layer that contains a solid electrolyte material), a metal halide, and a first solvent to form a mixture of dissolved and undissolved materials. Next at step 120, the undissolved materials are removed from the solution containing the dissolved materials by, e.g., filtering. After removing the undissolved materials, all that remains is a solution containing dissolved materials. Next, at step 130, the solvent is removed from the solution to form a composite containing a metal sulfide and an alkali metal halide.

The composite may then be washed at step 140 with a second solvent in order to separate the metal sulfide from the alkali metal halide. Washing the composite includes combining a second solvent with the composition and mixing. The alkali metal halide in the composite may be soluble in the second solvent, and so may dissolve during the washing step, thereby separating it from the metal sulfide. The washing may be accomplished in an inert atmosphere at a temperature from about 25° C. to about 100° C. After the second solvent is well-mixed with the composite, the mixture may be separated by filtration or another separation method known in the art.

Once the metal sulfide and the alkali metal halide are separated, the metal sulfide and the alkali metal halide may then be heat treated at step 150.

Contacting the solid electrolyte and the metal halide in the first solvent in step 110 may include agitation in the form of mixing, grinding, milling, tumbling, or stirring. The contacting may take place for about 1 minute to about 36 hours at a temperature from about −20° C. to about 100° C., and causes a reaction between the metal halide and the solid electrolyte. Through this reaction, an alkali metal halide and a metal sulfide is produced as well as other non-soluble materials or undissolved materials.

The temperature during the contacting step may be from about −20° C. to about 0° C., about −20° C. to about 25° C., about −20° C. to about 50° C., about −20° C. to about 75° C., about −20° C. to about 100° C., about 0° C. to about 100° C., about 25° C. to about 100° C., about 50° C. to about 100° C., about 75° C. to about 100° C., from about 0° C. to about 50° C., or from about 0° C. to about 25° C. As another example, the temperature may be about −20° C.,-10°C., 0° C., 10° C., 20° C., 30° C., 40° C., 50° C., 60° C., 70° C., 80° C., 90° C., or about 100° C.

In step 120, the undissolved materials may be removed using techniques including but are not limited to centrifugation, filtration, gravity settling, cooling, or any combination thereof.

In some embodiments, in step 130 the solvent is removed to produce a mixture of the metal sulfide and the alkali metal. The solvent may be removed by heating under vacuum conditions for about 1 hour to about 4 hours at a temperature ranging from about 60° C. to about 160° C. The drying may take place under vacuum for about 1.5 hours, about 2 hours, about 2.5 hours, about 3 hours, about 3.5 hours, or about 4 hours. The temperature may be about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75°C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97°C., about 98° C., about 99° C., about 100° C., about 101° C., about 102° C., about 103° C., about 104° C., about 105° C., about 106° C., about 107° C., about 108° C., about 109° C., about 110° C., about 110° C., about 111° C., about 112° C., about 113° C., about 114° C., about 115° C., about 116°C., about 117° C., about 118° C., about 119° C., about 120° C., about 121° C., about 122° C., about 123° C., about 124° C., about 125° C., about 126° C., about 127° C., about 128° C., about 129° C., about 130° C., about 131° C., about 132° C., about 133° C., about 134° C., about 135° C., about 136°C., about 137° C., about 138° C., about 139° C., about 140° C., about 141° C., about 142° C., about 143° C., about 144° C., about 145° C., about 146° C., about 147° C., about 148° C., about 149° C., about 150° C., about 151° C., about 152° C., about 153° C., about 154° C., about 155° C., about 156°C., about 157° C., about 158° C., about 159° C., or about 160° C.

In some embodiments, step 130 is optional and the second solvent may be added to the solution containing the dissolved materials. This may cause the metal sulfide to precipitate out of solution. The metal sulfide may then be removed from the solution and optionally heat treated.

Step 150 is optional and includes heat treating the individual components in an inert atmosphere. The heat treatment may be performed in a crystallizer, an oven, a kiln, or another apparatus known in the art of crystallization. The temperature used during step 150 may be from about 25° C. to about 900° C., about 200° C. to about 700° C., or about 300° C. to about 500° C. For example, the temperature during step 150 may be about 25° C., 50° C., 75° C., 100° C., 150° C., 200° C., 250° C., 300° C., 350° C., 400° C., 450° C., 500° C., 550° C., 600° C., 650° C., 700° C., 750° C., 800° C., 850° C., or about 900° C.

In the above reactions, A_{w}P_{y}S_{z}Xᵤ is a solid electrolyte, M_{α}X_{β}is a metal halide, AX is an alkali metal halide, and MS_{y} is a metal sulfide. In some embodiments, all or some of the phosphorus in the solid electrolyte may be replaced with germanium, silicon, boron, zinc, gallium, aluminum or indium. In some embodiments, all or some of the sulfur in the solid electrolyte may be replaced with oxygen.

In the reactions above, w may be a number from about 3 to about 9. In some embodiments, w may be about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, or about 9.0.

In the reactions above, y may be a number greater than about 1 and less than about 4. In some embodiments, y may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, or about 4.0.

In the reactions above, z is a number from about 1 to about 40. In some embodiments, z may be about 1.0, about 2.0, about 3.0, about 4.0, about 5.0, about 6.0, about 7.0, about 8.0, about 9.0, about 10.0, about 11.0, about 12.0, about 13.0, about 14.0, about 15.0, about 16.0, about 17.0, about 18.0, about 19.0, about 20.0, about 21.0, about 22.0, about 23.0, about 24.0, about 25.0, about 26.0, about 27.0, about 28.0, about 29.0, about 30.0, about 31.0, about 32.0, about 33.0, about 34.0, about 35.0, about 36.0, about 37.0, about 38.0, about 39.0, or about 40.0.

In the reactions above, u may be a number ranging from 0 to about 3. In some embodiments, u may be about 0.0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, or about 3.0.

In the reactions above, α may be a number from about 1 to about 5. In some embodiments, α may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β may be a number from about 4 to about 12. In some embodiments, β may be about 4, about 5, about 6, about 7, about 8, about 9, about 10, about 11, or about 12.

In the above reactions, A is an alkali metal, M may be a metalloid, transition metal, or post-transition metal, and X is a halogen. Non-limiting examples of alkali metals include Li, Na, K, Rb, and Cs. In some embodiments, M may be a metalloid. Non-limiting examples of metalloids include boron, silicon, germanium, antimony, and tellurium. In some embodiments, M may be a transition metal. Non-limiting examples of transition metals include scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, and mercury. In some embodiments, M may be a post-transition metal. Non-limiting examples of post-transition metals include aluminum, gallium, indium, thallium, tin, lead, and bismuth.

Examples of alkali metal halides include but are not limited to LiCl, NaCl, NaBr, NaI, KCl, KBr, KI, and any combination thereof.

In some embodiments, the undissolved material may comprise the alkali metal, phosphorous, oxygen, or sulfur. In some examples, the undissolved material may include an alkali metal carbonate, an alkali metal sulfate, an alkali metal phosphate, and alkali metal hydroxide, or any combination thereof.

The above reactions may be carried out in a first solvent. The first solvent may be a polar organic solvent including but not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The first solvent may futher include a hydrocarbon solvent which may include an alkane, a blend of alkanes, xylene (including para-, meta-, and ortho-xylene), toluene, benzene, heptane, octane, decalin, 1,2,3,4-tetrahydronaphthalene, or combinations thereof. The alkane may include alkanes having from 4 to 20 carbon atoms. The hydrocarbon solvent may be an alkene, alkyne, or a combination thereof, including but not limited to those with linear, branched, or ring structures and boiling points between 30° C. and 250° C. The solvent may include DMSO, acetone, DMA, chloroform, methyl dichloride, or any combination thereof.

The second solvent used in this reaction may function as an antisolvent and may include but is not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The second solvent may be one or more of DMSO, acetone, DMA, chloroform, methyl dichloride, or pyridine.

In preferred embodiments, the first solvent and the second solvent are not the same solvent.

In some embodiments, the solid electrolyte may comprise lithium, phosphorus and sulfur.

In some embodiments, the solid electrolyte may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In).

In some embodiments, the solid electrolyte may include an argyrodite-type electrolyte represented by Li⁺_{(12-n-w)}Bⁿ⁺X²⁻_{6-w}Y^{-z}_{w}, wherein B is P, As, Ge, Ga, Sb, Si, Sn, Al, In, Ti, V, Nb, or Ta; X is S, Se, or Te; Y is Cl, Br, I, F, BH₄, BF₄, CN, OCN, SCN, or N₃; wherein z is 0 or 1; wherein n is a number from about 3 to about 5, such as 3, 4, or 5; and wherein w is any number from about 0 to about 2.

In some embodiments, solid electrolyte material may be one expressed by the formula Li_{(A)}M_{(α)}M2_{(β)}P_{(B)}S_{(C)}X_{(D)}, where M1 and M2 are each independently an alkali metal including Li, Na, K, Rb, or Cs, or an alkaline earth metal including Be, Mg, Ca, Sr, or Ba; X is a halogen including F, Cl, Br, or I; 2≤A≤9; 0≤α≤2; 0≤β≤2; 1≤B≤3; 2≤C≤12; and 0≤D≤3. In some embodiments, the solid electrolyte may include one or more of Li₃PS₄, Li₇PS₆, Li₇P₃S₁₁, Li₇P₂S₈X, Li₄PS₄X, Li₉P₃S₁₁X, Li₃M1_{α}M2_{β}PS₄, Li₃M1_{α}M2_{β}PS_{(4+β)}X_{(α)}, Li₇M1_{α}M2_{β}PS₆, Li₇M1_{α}M2_{β}P₃S₁₁X_{(a+β)}, Li₄M1_{α}M2_{β}PS₄X_{(1+a+β)}, Li₆M1_{α}M2_{β}PS₅X_{(1+a+β)}, or Li₇M1_{α}M2_{β}P₂S₈X_{(1+a+β)}.

In some embodiments, the solid electrolyte may be one expressed by the formula Li_{(A)}M1_{(α)}M2_{(β)}P_{(B)}S_{(C)}O_{(E)}X_{(D)}where M1, M2, and X are described above, 2≤A≤9, 0≤α≤2, 0≤β≤2, 1≤B≤3, 2≤C≤12, 0≤D≤3, and 0≤E≤1. In some embodiments, the solid electrolyte material may include Li₃PO₄, Li₃PS₃O, Li₇PS_{(6-E)}O_{(E)}, Li₇P₃S₇O₍₄₎, Li₇P₂S₆O₂X, Li₄PS_{(4-E)}O_{(E)}X, Li₉P₃S₁₁X, Li₃M1_{α}M2_{β}PS₃O, Li₃M1_{α}M2_{β}PS_{(4+β)}X_{(α)}, Li₇M1_{α}M2_{β}PS_{(6-E)}O_{(E)}, Li₇M1_{α}M2_{β}P₃S₅O₃X_{(a+β)}, Li₄M1_{α}M2_{β}PS₄X_{(1+a+β)}, Li₆M1_{α}M2_{β}PS₅X_{(1+a+β)}, or Li₇M1_{α}M2_{β}P₂S₈X_{(1+a+β)}.

In a further embodiment, the solid electrolyte may be a halide solid electrolyte and may have the structure Li-M-X, wherein M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6-[(β*4)+(1-β)*3]; X and Y are each independently a halogen such as F, Cl, Br, or I; M is an element with an oxidation state of 4+ such as Ti, Zr, Hf, or Rf; and N is an element an oxidation state of 3+ such as Ga, In, Tl, Sc, Y, Fe, Ru, Os, or Er. Examples of halide electrolytes include Li₂ZrCl₆, Li₃InCl₆, Li_{2.25}Hf_{0.75}Fe_{0.25}Cl₄Br₂.

The metal halide may comprise boron, silicon, germanium, antimony, tellurium, scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, and bismuth. The metal halide further comprises one or more of F, Cl, Br, or I. In some exemplary embodiments, the metal halide includes boron, silicon, germanium, zirconium, tin, or any combination thereof.

In some embodiments, the molar ratio between the solid electrolyte and the metal halide may range from 99:1 to 1:99. In some embodiments, the molar ratio between the solid electrolyte and the metal halide may range from 80:1 to 1:80, from 70:1 to 1:70, from 60:1 to 1:60, from 50:1 to 1:50, from 40:1 to 1:40, from 30:1 to 1:30, from 20:1 to 1:20, from 10:1 to 1:10 , from 5:1 to 1:5, or from 3:1 to 1:3.

The non-soluble material may include a phosphorous sulfide material such as P₄S₃, P₄S₄, P₄S₅, P₄S₆, P₄S₇, P₄S₈, P₄S₉ or P₄S₁₀ (P₂S₅), P₄S₁₁, P₄S₁₂, P₄S₁₃, P₄S₁₄ or P₄S_{20.} The non-soluble material additionally or alternatively include alkali metal sulfates, carbonates, oxides, phosphates, nitrates, hydroxides, or combinations thereof.

After the removal of the non-soluble materials, all that remains is the solvent, the alkali metal and the metal sulfide.

In some embodiments, the solvent is removed to produce a mixture of the metal sulfide and the alkali metal. The solvent may be removed by heating under vacuum conditions for about 1 hour to about 4 hours at a temperature ranging from about 60° C. to about 160° C. The drying may take place under vacuum for about 1.5 hours, about 2 hours, about 2.5 hours, about 3 hours, about 3.5 hours, or about 4 hours. The temperature may be about 60° C., about 61° C., about 62°C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84°C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 110° C., about 111°C., about 112° C., about 113° C., about 114° C., about 115° C., about 116° C., about 117° C., about 118° C., about 119° C., about 120° C., about 121° C., about 122° C., about 123° C., about 124° C., about 125° C., about 126° C., about 127° C., about 128° C., about 129° C., about 130° C., about 131°C., about 132° C., about 133° C., about 134° C., about 135° C., about 136° C., about 137° C., about 138° C., about 139° C., about 140° C., about 141° C., about 142° C., about 143° C., about 144° C., about 145° C., about 146° C., about 147° C., about 148° C., about 149° C., about 150° C., about 151°C., about 152° C., about 153° C., about 154° C., about 155° C., about 156° C., about 157° C., about 158° C., about 159° C., or about 160° C.

In some embodiments, an argyrodite electrolyte material, silicon chloride, and a first solvent are mixed together. The silicon chloride reacts with the argyrodite electrolyte material to produce a lithium halide, silicon sulfide, and P₂S₅. The silicon sulfide and some of the lithium halide form a complex that is soluble in the first solvent, thereby forming a solution. The remaining lithium halide is soluble in the first solvent, while the P₂S₅ is not soluble. This difference in solubility allows for the P₂S₅ to be filtered from the solution, leaving only the silicon sulfide and the lithium halide. The first solvent may then be removed by drying to produce a composite of silicon sulfide and the lithium halide. The lithium halide may be separated from the silicon sulfide by redissolving it in a second solvent. The general reaction for this is:
1. Contacting an argyrodite material and silicon chloride in a first solvent

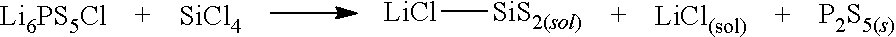

2. Filtering to remove undissolved materials, including P₂S₅

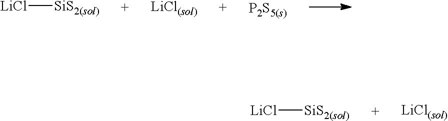

3. Removing the first solvent

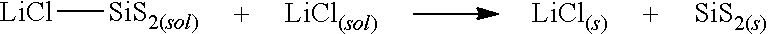

In some embodiments, the solid electrolyte is contained in an electrode layer such as a positive electrodes (i.e., cathode layers) or negative electrodes (i.e., anode layers).

When the solid electrolyte is in an electrode layer such as a cathode layer or anode layer, the solid electrolyte may be in a composite form, referred to herein as an electrode composite, with other materials such as electrode active materials (i.e., anode active materials or cathode active materials), conductive additives, and binders. These materials are mixed together and placed on a current collector. Thus, when used in the methods of the present disclosure, the electrode layer may include the current collector.

In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may include an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

The binder may be present in the electrode composite in an amount from about 1% to about 30% by weight of the electrode composite. For example, the binder may be present in the slurry in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the electrode composite.

The conductive additive may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanostructures, carbon nanowires, activated carbon, or any combination thereof.

In some embodiments, the conductive additive may be present in the electrode composite in an amount from about 0% to about 15% by weight of the electrode composite. In some aspects, the conductive additive may be present in the electrode composite in an amount from about 0% to about 10%, or about 0% to about 5% by weight of the electrode composite. In some additional aspects, the conductive additive may be present in the slurry in an amount of about 0%, 1%, 2%, 3%, 4%, 5%, 6%, 7%, 8%, 9%, 10%,11%, 12%, 13%, 14%, or about 15% by weight of the electrode composite. In an example embodiment, the conductive additive is present in the electrode composite in an amount from about 0% to about 5% by weight of the electrode composite.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D₅₀) may be determined through any method known to those having ordinary skill in the art.

The solid electrolyte may be present in the electrode composite in an amount from 0% to about 60% by weight of the electrode composite; for example, the solid electrolyte may be present in the electrode composite in an amount from 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight. In some aspects, the solid electrolyte may be present in the electrode composite in an amount of about 5%, 10%, 15%, 20%, 25%, 30%, 35%, 40%, 45%, 50%, 55%, or 60% by weight of the electrode composite. In an example embodiment, the solid electrolyte material is present in the electrode composite in an amount from about 35% to about 45% by weight.

The solid electrolyte may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns.

In some embodiments, the electrode active material comprises a negative electrode active material, also referred to as an anode active material. The anode active material preferably is an inorganic material. The anode active material may comprise one or more inorganic materials such as silicon (Si), silicon alloys, tin (Sn), tin alloys, germanium (Ge), germanium alloys, graphite, Li₄Ti₅O₁₂ (LTO) or other known anode active materials and combinations thereof.

In some embodiments, the electrode active material comprises a positive electrode active material, also referred to as a cathode active material. The cathode active material may include nickel-manganese-cobalt (“NMC”) which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or any combination thereof. In another embodiment, the cathode active material may comprise a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1), or any combination thereof. In yet another embodiment, the cathode active material may comprise a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur(S). In additional embodiments, the cathode active material may comprise a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or combinations thereof.

The electrode active material may be present in the electrode composite in an amount from about 30% to about 98% by weight of the electrode composite. In some aspects, the electrode active material may be present in the slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the electrode composite.

The current collector may comprise copper, aluminum, nickel, titanium, stainless steel, magnesium, iron, zinc, indium, germanium, silver, platinum, gold, or any combination thereof.

In some embodiments, the current collector may have a thickness from about 5 μm to about 10 μm.

In some embodiments, the current collector includes a carbon coating.

In preferred embodiments, the current collector comprises copper, nickel, steel, or a combination thereof.

The separator layer (also referred to as the solid electrolyte layer) includes a solid electrolyte and a binder.

The separator layer may include a solid electrolyte in an amount from about 30% to about 99% by weight of the separator layer. In some aspects, the solid electrolyte may be present in the separator layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 99%, about 40% to about 99%, about 45% to about 99%, about 50% to about 99%, about 55% to about 99%, about 60% to about 99%, about 65% to about 99%, about 70% to about 99%, about 75% to about 99%, about 80% to about 99%, about 85% to about 99%, about 90% to about 99%, about 40% to about 90%, about 40% to about 80%, about 40% to about 70%, about 40% to about 60%, about 40% to about 55%, about 40% to about 50%, or about 40% to about 45% by weight of the separator layer.

The binder may be present in the separator layer in an amount from about 1% to about 30% by weight of the separator layer. For example, the binder may be present in the separator layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the separator layer.

In some embodiments, the solid electrolyte is contained in a solid-state electrochemical cell which is constructed of an interconnected system of positive electrodes or cathode layers, negative electrodes or anode layers, and separator layers or solid electrolyte layers.

### EXAMPLES

### Example 1

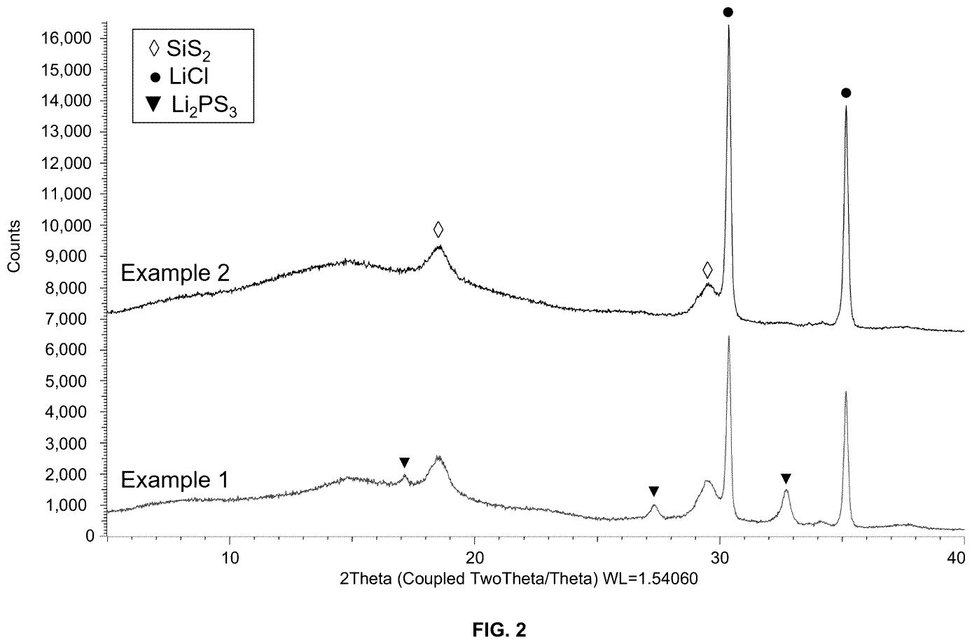

A solid electrolyte with an argyrodite phase and formula Li₆SP₅Cl, a metal halide with the formula SiCl₄, and 10 ml of acetonitrile was added to a glass vial. The molar ratio between the solid electrolyte and the metal halide was 1:1. These materials were mixed for 4 hours at room temperature. After the 4 hours, the mixture was centrifuged. A yellow solution formed with undissolved material at the bottom of the vial. The mixture was filtered to remove the undissolved materials. The yellow solution was then heated to 60° C. while under vacuum for 1 hour, thereby forming a powder. This powder was then heated to 350° C. for 1 hour. The dried powder was then scanned using an X-ray diffractometer (XRD) and identified to be a mixture of SiS₂, LiCl, and a Li₂PS₃ material shown in FIG. 2.

### Example 2

Example 2 was conducted in the same manner as Example 1 except the molar ratio between the solid electrolyte material and the metal halide was 1:5. The dried powder of Example 2 was scanned using an X-ray diffractometer (XRD) and identified to be a mixture of only SiS₂ and LiCl shown in FIG. 2.

### Example 3

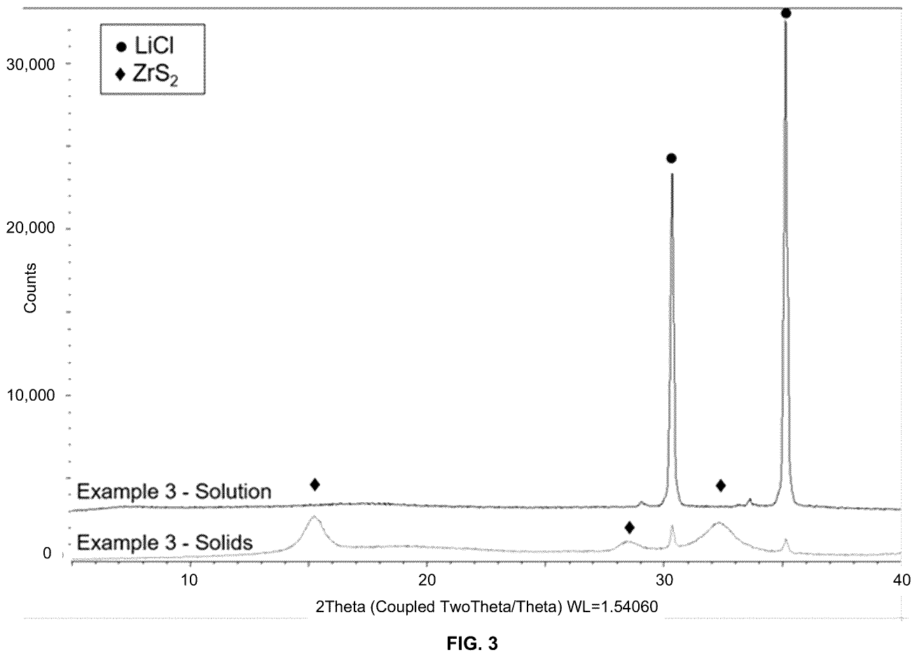

A solid electrolyte with an argyrodite phase and formula Li₆SP₅Cl, a metal halide with the formula ZrCl₄, and 10 ml of ethyl acetate was added to a glass vial. The molar ratio between the solid electrolyte and the metal halide was 1:1.5. These materials were mixed overnight, 15 hours, at room temperature. After the 15 hours, the mixture was centrifuged. A yellow solution had formed with undissolved material at the bottom of the vial. The mixture was filtered to remove the undissolved materials. The yellow solution was then combined with pyridine at a volume ratio of 50:50, causing a material to precipitate from the solution, forming a mixture. The mixture was centrifuged. The solids were removed via filter, dried, and heated to 475° C. for 1. The XRD of this material was collected and shown to be ZrS₂ and a small amount of LiCl. This material is marked as “Example 3-Solids” in FIG. 3. The solution from the centrifuging step post pyridine addition was heated to 60° C. while under vacuum for 1 hour, thereby forming a powder. This powder was then heated to 475° C. for 1. The XRD of this powder was collected and shown to be LiCl. This material is marked as “Example 3-Solution” in FIG. 3.

### Example 4

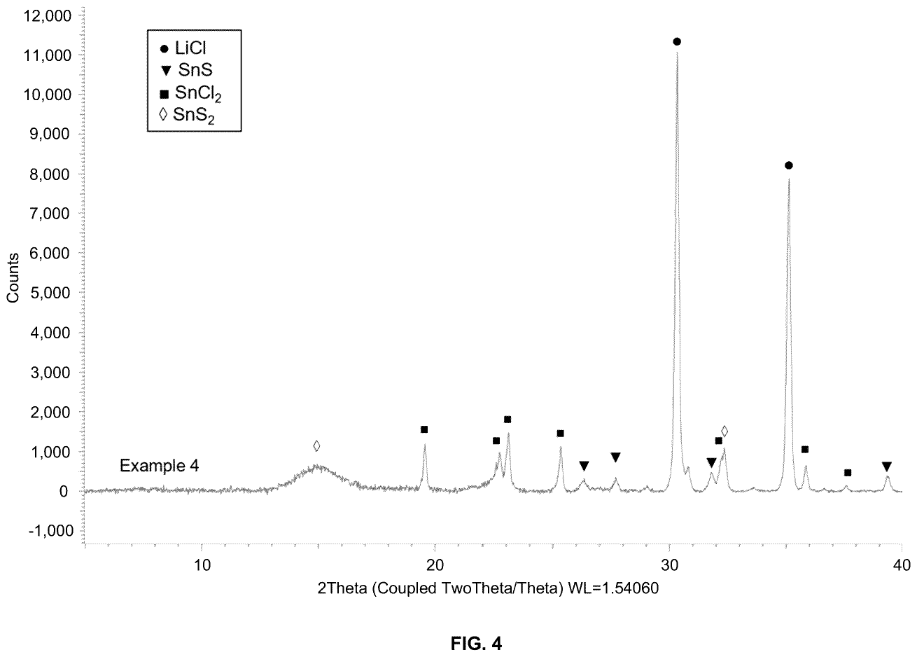

A solid electrolyte with an argyrodite phase and formula Li₆SP₅Cl, a metal halide with the formula SnCl₂, and 10 ml of acetonitrile was added to a glass vial. The molar ratio between the solid electrolyte and the metal halide was 1:1. These materials were mixed overnight, 15 hours, at room temperature. After the 15 hours, the mixture was centrifuged. A yellow solution had formed with undissolved material at the bottom of the vial. The mixture was filtered to remove the undissolved materials. The yellow solution was then dried, and heated to 350° C. for 1. The XRD of this material was collected and shown to be a mixture containing SnS, SnS₂, LiCl, and unreacted SnCl₂ shown in FIG. 4.

What is claimed is:

1. A method for recycling a solid electrolyte comprising:
contacting a solid electrolyte with a metal halide in a solvent to produce a mixture comprising a metal sulfide, an alkali metal salt, and undissolved material;
removing the undissolved material to form a solution; and
removing the solvent from the solution to form a composite comprising a metal sulfide and an alkali metal salt.

2. The method of claim 1, wherein the solid electrolyte is contained in an electrode layer that comprises an electrode active material, a conductive additive, a binder, and a current collector.

3. The method of claim 1, wherein the molar ratio between the solid electrolyte and the metal halide is from 99:1 to 1:99.

4. The method of claim 1, wherein the solid electrolyte comprises lithium, phosphorus and sulfur.

5. The method of claim 1, wherein the metal halide comprises boron, silicon, germanium, antimony, tellurium, scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth.

6. The method of claim 1, wherein the metal halide comprises fluorine, chlorine, bromine, or iodine.

7. The method of claim 1, wherein the solvent comprises an ether, ester, nitrile, imine, or hydrocarbon.

8. The method of claim 1, wherein the metal sulfide comprises boron, silicon, germanium, antimony, tellurium, scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth.

9. The method of claim 1, wherein the alkali metal salt comprises LiF, LiCl, LiBr, or LiI.

10. The method of claim 1, wherein the contacting comprises mixing, grinding, or tumbling.

11. The method of claim 1, wherein the undissolved material comprises lithium, phosphorous, sulfur, or a combination thereof.

12. The method of claim 1, wherein the undissolved material comprises an alkali metal carbonate, an alkali metal sulfate, an alkali metal phosphate, or an alkali metal hydroxide.

13. The method of claim 1, wherein removing the undissolved material comprises filtering, centrifuging, decanting, or a combination thereof.

14. The method of claim 1, wherein removing the solvent comprises drying.

15. The method of claim 1, further comprising washing the composite with a solvent to separate the alkali metal salt and the metal sulfide from the undissolved material.

16. A method for recycling a solid electrolyte contained in an electrode layer or a separator layer comprising:
contacting an electrode layer comprising a solid electrolyte or a separator layer comprising a solid electrolyte with a metal halide in a solvent to produce a mixture comprising a metal sulfide, an alkali metal salt, and undissolved material;
removing the undissolved material forming a solution; and
removing the solvent from the solution to form a composite containing a metal sulfide and an alkali metal salt.

17. The method of claim 16, wherein the molar ratio between the solid electrolyte and the metal halide material is between 99:1 to 1:99.

18. The method of claim 16, wherein the solid electrolyte comprises lithium, phosphorus and sulfur.

19. The method of claim 16, wherein the metal halide comprises boron, silicon, germanium, antimony, tellurium scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth.

20. The method of claim 16, wherein the metal halide comprises fluorine, chlorine, bromine, or iodine.

21. The method of claim 16, wherein the solvent comprises an ether, ester, nitrile, imine, or hydrocarbon.

22. The method of claim 16, wherein the metal sulfide comprises boron, silicon, germanium, antimony, tellurium scandium, titanium, vanadium, chromium, manganese, iron, cobalt, nickel, copper, zinc, yttrium, zirconium, niobium, technetium, ruthenium, rhodium, palladium, silver, cadmium, hafnium, tantalum, tungsten, rhenium, osmium, iridium, platinum, gold, mercury, aluminum, gallium, indium, thallium, tin, lead, or bismuth.

23. The method of claim 16, wherein the alkali metal salt comprises LiF, LiCl, LiBr, or LiI.

24. The method of claim 16, wherein the contacting comprises mixing, grinding, or tumbling.

25. The method of claim 16, wherein the undissolved material comprises lithium, phosphorous, sulfur, an active material, a conductive additive or a current collector.

26. The method of claim 16, wherein removing the undissolved material comprises filtering, centrifuging, decanting, or a combination thereof.

27. The method of claim 16 wherein removing the solvent comprises drying.

28. The method of claim 16, further comprising washing the composite with a solvent to separate the alkali metal salt and the metal sulfide.
